(19) United States
(12) Patent Application Publication
(10) Pub. No.: US 2009/0142016 A1
(43) Pub. Date: Jun. 4, 2009

(54) PLASMONIC OPTICS FOR PLASMONIC CIRCUITS

(75) Inventors: Vladimir A. Aksyuk, Westfield, NJ (US); Girsh Blumberg, New Providence, NJ (US)

Correspondence Address: MENDELSOHN & ASSOCIATES, P.C., 1500 JOHN F. KENNEDY BLVD., SUITE 405, PHILADELPHIA, PA, 19102, US

(73) Assignee: LUCENT TECHNOLOGIES INC., Murray Hill, NJ (US)

(21) Appl. No.: 11/949,216

(22) Filed: Dec. 3, 2007

(51) Int. Cl. G02B 6/12; G02B 3/00

(52) U.S. Cl. 385/14; 359/722

(57) ABSTRACT

According to one embodiment, a circuit element for a plasmonic circuit is formed using a dielectric layer having two portions, each characterized by a different electric permittivity. The dielectric layer is adjacent to a metal layer, with the interface between the layers defining a conduit for propagation of surface plasmons. A dielectric boundary between the two portions of the dielectric layer is shaped to enable the circuit element to change one or more of propagation direction, cross-section, spectral composition, and intensity distribution for a beam of surface plasmons received by the circuit element.

### BACKGROUND OF THE INVENTION

1. Field of the Invention

The present invention relates to optical communication equipment and, more specifically, to plasmonic circuits.

2. Description of the Related Art

Optical interconnects can carry data with a capacity that exceeds that of electronic interconnects by several orders of magnitude. Unfortunately, fiber-optic components can be about one thousand times larger than electronic components, and the two technologies are difficult to combine on the same circuit. External optical interconnects that connect different parts of electronic chips via air or fiber-optic cables have also been proposed. However, the resulting arrangements can be bulky and/or labor intensive.

One approach to combining optical and electronic components in a circuit having nanometer-size features is based on the use of surface plasmons (SPs), also often referred to as surface-plasmon polaritons. The branch of photonics that deals with SPs is called plasmonics, and circuits that can carry SP signals are called plasmonic circuits. Currently, various circuit elements for plasmonic circuits are being actively developed.

### SUMMARY OF THE INVENTION

According to one embodiment, a circuit element for a plasmonic circuit is formed using a dielectric layer having two portions, each characterized by a different electric permittivity. The dielectric layer is adjacent to a metal layer, with the interface between the layers defining a conduit for propagation of surface plasmons. A dielectric boundary between the two portions of the dielectric layer is shaped to enable the circuit element to change one or more of propagation direction, cross-section, spectral composition, and intensity distribution for a beam of surface plasmons received by the circuit element.

According to one embodiment, an integrated circuit comprises plasmonic circuitry having at least one plasmonic element that comprises an electrically conducting layer and a dielectric layer adjacent to the electrically conducting layer. An interface between the electrically conducting layer and the dielectric layer defines a conduit for propagation of surface plasmons. The dielectric layer comprises at least a first portion and a second portion. The first and second portions are adjacent different parts of the interface, have different electric permittivities, and define a dielectric boundary between them.

According to another embodiment, a method of manipulating surface plasmons comprises the step of propagating surface plasmons through a conduit defined by an interface between (i) an electrically conducting layer and (ii) a dielectric layer adjacent to the electrically conducting layer, wherein the dielectric layer comprises at least a first portion and a second portion that are adjacent different parts of the interface, have different electric permittivities, and define a dielectric boundary between them.

### BRIEF DESCRIPTION OF THE DRAWINGS

Other aspects, features, and benefits of the present invention will become more fully apparent from the following detailed description, the appended claims, and the accompanying drawings in which:

FIGS. 1A-B graphically illustrate certain physical properties of surface plasmons (SPs);

FIG. 2 shows a top view of a plasmonic circuit according to one embodiment of the invention;

FIGS. 3A-B show top and side cross-sectional views, respectively, of a plasmonic circuit element that can be used in the circuit of FIG. 2 according to one embodiment of the invention;

FIGS. 4A-B show top views of a plasmonic circuit element that can be used in the circuit of FIG. 2 according to another embodiment of the invention;

FIG. 5 shows a top view of a plasmonic circuit element that can be used in the circuit of FIG. 2 according to yet another embodiment of the invention;

FIG. 6 shows a top view of a plasmonic circuit element that can be used in the circuit of FIG. 2 according to yet another embodiment of the invention;

FIG. 7 shows a top view of a plasmonic circuit element that can be used in the circuit of FIG. 2 according to yet another embodiment of the invention;

FIG. 8 shows a top view of a plasmonic circuit element that can be used in the circuit of FIG. 2 according to yet another embodiment of the invention;

FIG. 9 shows a top view of a plasmonic circuit element that can be used in the circuit of FIG. 2 according to yet another embodiment of the invention; and

FIG. 10 shows a top view of a plasmonic circuit element that can be used in the circuit of FIG. 2 according to yet another embodiment of the invention.

### DETAILED DESCRIPTION

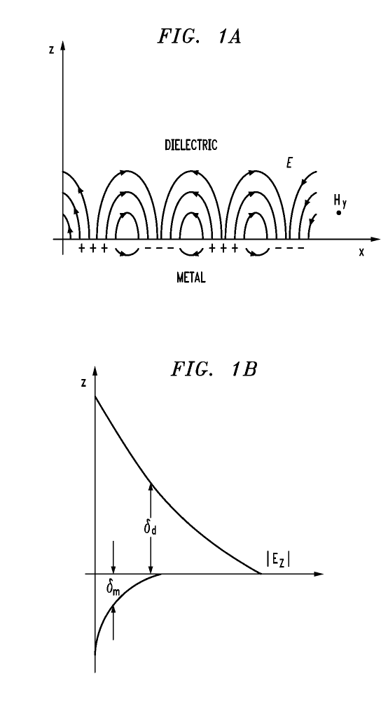

FIGS. 1A-B graphically illustrate certain physical properties of surface plasmons (SPs). More specifically, FIG. 1A illustrates the combined electromagnetic-wave and surface-charge character of SPs. FIG. 1B graphically shows the surface-bound nature of SPs.

Referring to FIG. 1A, SPs are surface-bound waves that can propagate, e.g., along a metal-dielectric interface. SPs can qualitatively be viewed as electromagnetic (e.g., light) waves that are trapped at the interface due to their interaction with free surface charges of the metal, with the interaction causing the surface charges to oscillate in resonance with the electromagnetic wave. The combined physical entity created via this resonant interaction is an SP.

In FIG. 1A, the x-y plane is orthogonal to the plane of the figure, and the z axis is orthogonal to the x-y plane. The metal-dielectric interface lies in the x-y plane. SPs are transverse magnetic in character, and the magnetic field, labeled H_{y}, is orthogonal to the plane of the figure. At the metal-dielectric interface, the electric field (E) is orthogonal to the interface boundary and is parallel to the z axis. The z component (E_{z}) of the electric field is at a maximum at z=0 and decreases exponentially as the distance from the interface boundary increases in either (±z) direction (see FIG. 1B). This evanescent character of the field represents the bound, non-radiative nature of SPs. In the dielectric, the characteristic (e-times) field attenuation length, δ_{d}, is on the order of one half of the wavelength of the corresponding electromagnetic wave. In the metal, the characteristic (e-times) field attenuation length, δₘ, is on the order of the skin depth.

A beam of SPs propagating along a metal-dielectric interface is gradually attenuated, primarily due to resistive losses in the metal. The rate of attenuation depends on the complex dielectric function of the metal and is different for different metals. For example, in the visible spectrum (e.g., for wavelengths between about 400 nm and about 800 nm), silver provides some of the longest SP propagation distances, which are in the range between about 10 μm and about 100 μm. Shifting the wavelength to about 1.5 μm can bring the propagation distance in silver up to about 1 mm.

One skilled in the art will appreciate that the SP propagation distance for a given metal-dielectric pair sets an upper lateral-size limit for the corresponding plasmonic circuit not having SP amplifiers or other signal-attenuation mitigating devices. As a result, circuit elements in plasmonic circuits are typically smaller than the SP propagation distance, and plasmonic circuits typically integrate many circuit elements in a sufficiently small area reachable by SPs before propagation losses become too significant. Attenuation length δ_{d} in the dielectric typically determines the thickness (height) of the dielectric layer. Similarly, attenuation length δₘ in the metal determines the characteristic feature size in the metal layer.

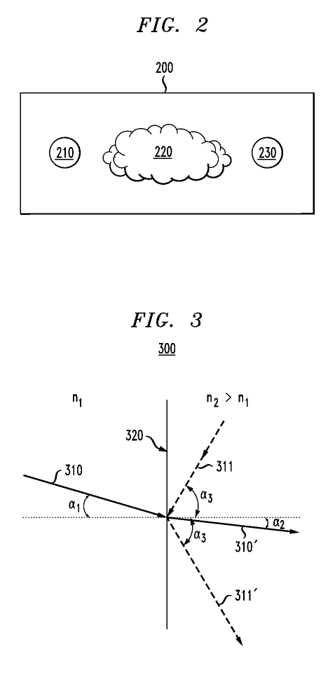

FIG. 2 shows a top view of a plasmonic circuit 200 according to one embodiment of the invention. Circuit 200 has a photon-to-SP (PSP) converter 210 adapted to receive an input beam of free-space photons and convert it into an SP beam (not explicitly shown). In a representative configuration, PSP converter 210 may direct the SP beam toward a circuit area 220 containing various circuit elements that can manipulate that beam, e.g., by changing its propagation direction, cross-section, spectral composition, intensity distribution, etc. An SP beam processed by circuit area 220 may be directed to an SP-to-photon (SPP) converter 230, where it is converted into an output beam of free photons. PSP and SPP converters can be implemented using, e.g., prism coupling, scattering from a topological defect, such as a protrusion or hole, and/or a periodic corrugation in the metal's surface. Representative examples, of PSP converter 210 and SPP converter 230 are described, e.g., in: (1) W. L. Barnes, et al., “Surface Plasmon Subwavelength Optics,” Nature, 14 Aug. 2003, v. 424, pp. 824-830; (2) D. Egorov, et al., “Two-Dimensional Control of Surface Plasmons and Directional Beaming from Arrays Subwavelength Apertures,” Phys. Rev. B, 2004, v. 70, pub. 033404; (3) E. Ozbay, “Plasmonics: Merging Photonics and Electronics at Nanoscale Dimensions,” Science, 13 Jan. 2006, v. 311, pp. 189-193; (4) U.S. Pat. Nos. 7,027,689, 7,039,277, and 7,039,315; and (5) U.S. patent application Ser. No. 11/983,538, filed on Nov. 9, 2007, all of which are incorporated herein by reference.

Circuit area 220 may contain one or more circuit elements that implement a desired function for plasmonic circuit 200. For example, circuit area 220 may contain one or more of SP deflectors, SP waveguides, SP mirrors, SP lenses, etc. Some circuit elements in circuit area 220 may be implemented using prior-art techniques, while at least one circuit element is implemented using an embodiment of the present invention, as described below.

FIGS. 3A-B show top and side cross-sectional views, respectively, of a plasmonic circuit element 300 that can be used in circuit area 220 according to one embodiment of the invention. In a representative configuration, circuit element 300 is used as an SP-beam deflector that can change the propagation direction for an SP beam, e.g., as indicated in FIG. 3A. For example, in one configuration of circuit element 300, an SP beam 310, e.g., received from PSP converter 210, impinges, at angle α₁ different from 90 degrees, upon a dielectric boundary 320, across which the index of refraction changes from n₁ to n₂>n₁. Herein, the term “index of refraction” refers to a conventional index of refraction related to the electric permittivity (∈) of the dielectric material as n=\sqrt{∈}. Upon encountering boundary 320, SP beam 310 refracts and continues as SP beam 310′ at angle α₂ different from angle α₁. In another configuration of circuit element 300, an SP beam 311 impinges at a relatively large angle α₃ upon dielectric boundary 320 from the side having the larger index of refraction. Upon encountering boundary 320, SP beam 311 is reflected due to an SP reflection phenomenon that is similar to conventional total internal reflection and continues on as SP beam 311′.

Referring to FIG. 3B, circuit element 300 is formed on a substrate 302, which is typically a common substrate for the corresponding plasmonic circuit, e.g., circuit 200 (FIG. 2). A metal layer 304 is formed over substrate 302. In one embodiment, metal layer 304 has a thickness of about the skin depth at the carrier frequency of SP beam 310. A dielectric layer 306 is formed over metal layer 304. An interface 305 between metal layer 304 and dielectric layer 306 serves as a conduit for SP beam 310.

Dielectric layer 306 has two portions 306a and 306b, having indices of refraction n₁ and n₂, respectively. Dielectric boundary 320 is the boundary between those portions. Conventional lithographic techniques may be used to form and appropriately pattern portions 306a and 306b to create a boundary of any desired shape. For example, conventional photoresist lithography may be used. Portions 306a and 306b may have the same thickness (as shown in FIG. 3B) or different thicknesses. In one embodiment, each of portions 306a and 306b has a thickness that is about one half of the wavelength of SP beam 310 in the corresponding dielectric material. In various embodiments, the dielectric materials for portions 306a and 306b can be selected, e.g., from a photoresist, silicon, silicon nitride, and silicon oxide.

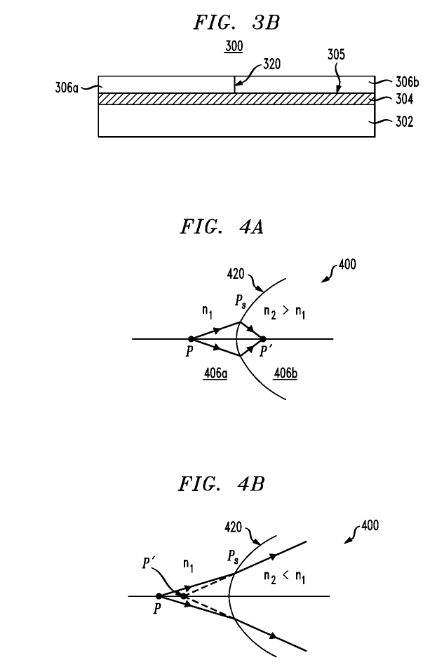

The SP dispersion relation is given by Eq. (1):

$${k}_{SP} ( ω ) = \frac{ω}{c} \sqrt{\frac{{ɛ}_{d} ( ω ) {ɛ}_{m} ( ω )}{{ɛ}_{d} ( ω ) + {ɛ}_{m} ( ω )}} \qquad ( 1 )$$

where k_{SP} is the magnitude of the SP's wavevector; ω is the frequency; c is the speed of light; ∈_{d}(ω) is the frequency-dependent electric permittivity of the dielectric; and ∈ₘ(ω) is the frequency-dependent electric permittivity of the metal. Eq. (1) can be analogized to the dispersion relation for photons in a bulk dielectric, which is given by Eq. (2):

$${k}_{P} = ( ω ) = \frac{ω}{c} \sqrt{{ɛ}_{d} ( ω )} \qquad ( 2 )$$

where k_{P} is the magnitude of the photon's wavevector. As known from conventional optics, Eq. (2) and the boundary conditions at a dielectric boundary characterized by a change in the electric permittivity from ∈_{d1} to ∈_{d2} (different from ∈_{d1}) lead to optical refraction. Similarly, Eq. (1) and the boundary conditions at boundary 320 lead to SP refraction, which produces the propagation-direction change shown in FIG. 3A for SP beam 310. Utilizing this analogy, one can use the insights developed in the design of conventional optical elements to design corresponding plasmonic circuit elements. A description of several representative plasmonic circuit elements, which can be used in circuit area 220, is given below in reference to FIGS. 4-9. For each of those plasmonic circuit elements, only a top view is shown because a cross-sectional side view is similar to that shown in FIG. 3B.

FIGS. 4A-B show top views of a plasmonic circuit element 400 that can be used in circuit area 220 according to another embodiment of the invention. Circuit element 400 has two dielectric portions 406a and 406b that are analogous to dielectric portions 306a and 306b respectively, of circuit element 300 (FIG. 3). Dielectric portions 406a and 406b have indices of refraction n₁ and n₂, respectively, and are separated by a parabola-shaped dielectric boundary 420. FIGS. 4A-B illustrate two representative SP-ray refraction patterns produced by dielectric boundary 420 for an SP point source, labeled P in each figure. The SP-ray refraction results in a formation of an image of the SP point source, which image is labeled P′. Depending on the relative values of n₁ and n₂, the curvature of dielectric boundary 420, and the location of SP point source P with respect to the dielectric boundary, the image can be real, as in FIG. 4A, or virtual, as in FIG. 4B. One skilled in the art will appreciate that parabola-shaped dielectric boundaries analogous to dielectric boundary 420 can be used to form plasmonic lenses.

FIG. 5 shows a top view of a plasmonic circuit element 500 that can be used in circuit area 220 according to yet another embodiment of the invention. Circuit element 500 has two dielectric portions 506a and 506b having indices of refraction n₁ and n₂ (>n₁), respectively, and separated by an ellipse-shaped dielectric boundary 520. Dielectric boundary 520 surrounds dielectric portion 506b. As shown in FIG. 5, plasmonic circuit element 500 is capable of condensing a collimated SP beam into a substantially point-like image labeled P′. One skilled in the art will appreciate that plasmonic circuit element 500 can be used to provide a relatively high SP coupling efficiency, e.g., between circuit area 220 and SPP converter 230 (see FIG. 2).

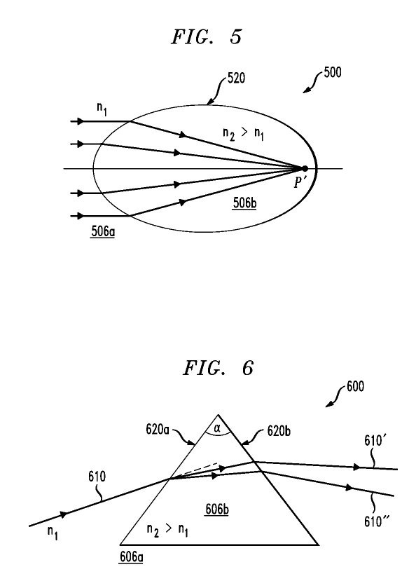

FIG. 6 shows a top view of a plasmonic circuit element 600 that can be used in circuit area 220 according to yet another embodiment of the invention. Circuit element 600 has two dielectric portions 606a and 606b having indices of refraction n₁ and n₂ (>n₁), respectively, and forming a triangular dielectric boundary 620. Dielectric boundary 620 surrounds dielectric portion 606b. As shown in FIG. 6, plasmonic circuit element 600 acts similar to a conventional optical prism to disperse an SP beam 610 in wavelength (frequency). For example, if SP beam 610 has two SP components with two different carrier frequencies, then, due to the frequency dependence of the SP dispersion relation given by Eq. (1), the two SP components refract differently at sides 620a and 620b of triangular dielectric boundary 620. The difference in the refraction produces spatial and directional separation of the SP components into SP beams 610′ and 610″, respectively, as indicated in FIG. 6.

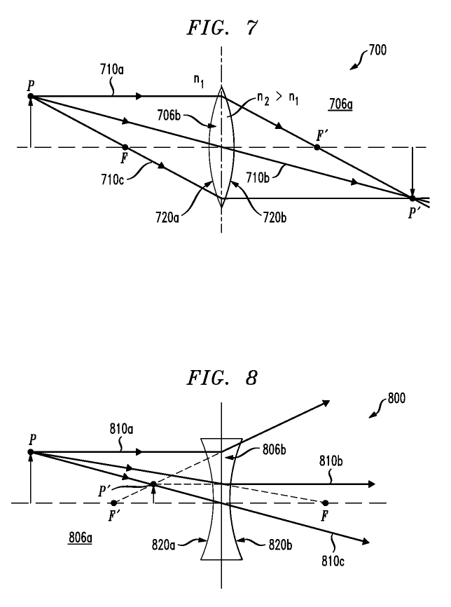

FIG. 7 shows a top view of a plasmonic circuit element 700 that can be used in circuit area 220 according to yet another embodiment of the invention. Circuit element 700 has two dielectric portions 706a and 706b having indices of refraction n₁ and n₂ (>n₁), respectively, and forming a dielectric boundary 720. Dielectric boundary 720 has two conjoined arch-shaped segments 720a-b that surround dielectric portion 706b. As shown in FIG. 7, plasmonic circuit element 700 acts similar to a conventional optical positive lens. For example, SP rays 710a-c trace the formation of an image (labeled P′) of an SP point source (labeled P).

FIG. 8 shows a top view of a plasmonic circuit element 800 that can be used in circuit area 220 according to yet another embodiment of the invention. Circuit element 800 has two dielectric portions 806a and 806b having indices of refraction n₁ and n₂ (>n₁), respectively, and forming a dielectric boundary 820. Dielectric boundary 820 surrounds dielectric portion 806b and has two arch-shaped segments 820a-b. As shown in FIG. 8, plasmonic circuit element 800 acts similar to a conventional optical negative lens. For example, SP rays 810a-c trace the formation of an image (labeled P′) of an SP point source (labeled P). Note that unlike image P′ of FIG. 7, which is a real image, image P′ of FIG. 8 is a virtual image.

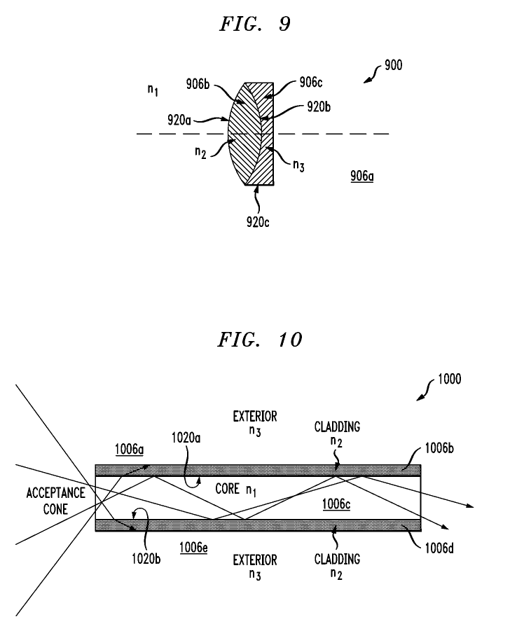

FIG. 9 shows a top view of a plasmonic circuit element 900 that can be used in circuit area 220 according to yet another embodiment of the invention. Circuit element 900 has three dielectric portions 906a, 906b, and 906c having indices of refraction n₁, n₂ (>n₁), and n₃ (>n₂), respectively. An arch-shaped boundary 920a separates dielectric portions 906a and 906b. An arch-shaped boundary 920b separates dielectric portions 906b and 906c. A segmented boundary 920c composed of three linear segments separates dielectric portions 906a and 906c. One skilled in the art will recognize that plasmonic circuit element 900 acts similar to a conventional optical achromatic doublet lens. Achromatic doublet lenses are designed to reduce chromatic and/or spherical aberrations. Thus, when used on-axis, circuit element 900 will condense a parallel input beam having multiple carrier wavelengths into a substantially point-like image. As such, circuit element 900 can be used to collimate or focus such SP beams.

FIG. 10 shows a top view of a plasmonic circuit element 1000 that can be used in circuit area 220 according to yet another embodiment of the invention. Circuit element 1000 has five dielectric portions 1006a-d having indices of refraction n₁, n₂ (>n₁), and n₃ (>n₁, or >n₂, or <n₁, or <n₂), as shown in the figure. Boundaries 1020a-b separate core portion 1006c from cladding portions 1006b and 1006d, respectively. One skilled in the art will recognize that plasmonic circuit element 1000 acts similar to a conventional planar optical waveguide. More specifically, if an SP beam is directed to cladding portion 1006c at an angle within the acceptance cone, then that beam will undergo multiple internal reflections from boundaries 1020a-b (similar to SP beam 311 in FIG. 3A) to remain substantially confined within the cladding portion, while propagating along it. As such, circuit element 1000 can be used to guide SP beams. Although cladding portion 1006c is shown in FIG. 10 as being straight, in a different embodiment, the cladding portion can be curved as long as the leakage of the SP energy from the cladding portion due to its curvature remains relatively small.

In one embodiment (not shown), a plasmonic circuit element acting as a Bragg reflector can be created based on the principles of the invention by using a periodic series of alternating stripes made of two dielectric materials having indices of refraction n₁ and n₂, respectively. Each stripe boundary causes a partial reflection of an SP beam impinging upon the boundary along its normal. For SP beams whose wavelength is close to four times the optical width of an individual stripe, the many partial reflections interfere constructively in the far field to cause the stripes to act collectively as a reflector having a relatively high reflection coefficient.

While this invention has been described with reference to illustrative embodiments, this description is not intended to be construed in a limiting sense. Although plasmonic circuit elements of the invention have been described in reference to dielectric layers having two solid portions of different electric permittivity, the invention is not so limited. In one embodiment, one of the dielectric-layer portions can be air or another dielectric fluid (e.g., gas or liquid). In another embodiment, one of the dielectric-layer portions can be vacuum. Although plasmonic lenses of the invention have been described in reference to double convex or double concave lenses, other plasmonic lenses, such as planoconvex, convex meniscus, planoconcave, and concave meniscus, can similarly be implemented. While plasmonic circuit elements of the invention have been described as having a metal layer, other electrically conducting materials can similarly be used. Circuit 200 can be implemented as an integrated circuit having both plasmonic and electronic circuit components. Various modifications of the described embodiments, as well as other embodiments of the invention, which are apparent to persons skilled in the art to which the invention pertains are deemed to lie within the principle and scope of the invention as expressed in the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Throughout the detailed description, the drawings, which are not to scale, are illustrative only and are used in order to explain, rather than limit the invention. The use of terms such as height, length, width, top, bottom, is strictly to facilitate the description of the invention and is not intended to limit the invention to a specific orientation. For example, height does not imply only a vertical rise limitation, but is used to identify one of the three dimensions of a three dimensional structure as shown in the figures. Such “height” would be vertical where the electrodes are horizontal but would be horizontal where the electrodes are vertical, and so on. Similarly, while all figures show the different layers as horizontal layers such orientation is for descriptive purpose only and not to be construed as a limitation.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

1. An integrated circuit, comprising plasmonic circuitry having at least one plasmonic element that comprises:
an electrically conducting layer; and
a dielectric layer adjacent to the electrically conducting layer, wherein:
an interface between the electrically conducting layer and the dielectric layer defines a conduit for propagation of surface plasmons;
the dielectric layer comprises at least a first portion and a second portion, wherein the first and second portions are adjacent different parts of the interface, have different electric permittivities, and define a dielectric boundary between said portions; and
at least one of the first and second portions comprises a photoresist.

2. The invention of claim 1, wherein the plasmonic element is adapted to change one or more of a propagation direction, a cross-section, a spectral composition, and an intensity distribution for a beam of surface plasmons received by the plasmonic element.

3. The invention of claim 1, wherein the dielectric boundary is parabola- or ellipse-shaped.

4. The invention of claim 1, wherein:
the dielectric boundary is prism-shaped; and
the plasmonic element is adapted to directionally disperse a beam of surface plasmons based on wavelength.

5. The invention of claim 1, wherein the dielectric boundary surrounds the second portion.

6. The invention of claim 5, wherein:
the dielectric boundary comprises two arch-shaped sections; and
the optical element is adapted to serve as a plasmonic lens.

7. The invention of claim 1, wherein:
the dielectric layer comprises a third portion; and
a dielectric boundary between the second and third portions is part of said plasmonic element.

8. The invention of claim 7, wherein:
the electric permittivity of the second portion is greater than the electric permittivity of the first portion;
the electric permittivity of the third portion is greater than the electric permittivity of the second portion; and
the plasmonic element is adapted to serve as an achromatic plasmonic doublet lens.

9. The invention of claim 7, wherein the dielectric boundaries between the first and second portions and between the second and third portions are adapted to guide a beam of surface plasmons along the part of the interface adjacent the second portion.

10. The invention of claim 1, further comprising a photon-to-surface-plasmon converter adapted to direct a beam of surface plasmons toward said plasmonic element.

11. The invention of claim 10, further comprising a surface-plasmon-to-photon converter, wherein said plasmonic element is adapted to direct at least a portion of said beam toward said photon-to-surface-plasmon converter.

12. The invention of claim 1, further comprising a surface-plasmon-to-photon converter adapted to receive a beam of surface plasmons from said plasmonic element.

13. The invention of claim 1, wherein:
at least one of the first and second portions comprises a fluid dielectric material; and
the plasmonic circuitry comprises one or more additional plasmonic elements.

14. The invention of claim 1, wherein:
each of the first and second portions comprises a solid: and
the first and second portions have different thicknesses.

15. (canceled)

16. A method of manipulating surface plasmons, comprising the step of:
propagating surface plasmons through a conduit defined by an interface between (i) an electrically conducting layer and (ii) a dielectric layer adjacent to the electrically conducting layer, wherein:
the dielectric layer comprises at least a first portion and a second portion that are adjacent different parts of the interface, have different electric permittivities, and define a dielectric boundary between said portions and
at least one of the first and second portions comprises a photoresist.

17. The invention of claim 16, further comprising the step of changing one or more of a propagation direction, a cross-section, and an intensity distribution for a beam of said surface plasmons.

18. The invention of claim 16, further comprising the step of changing a spectral composition for a beam of said surface plasmons.

19. The invention of claim 16, further comprising the steps of:
converting an input beam of photons into a beam of surface plasmons; and
directing said beam of surface plasmons through the conduit toward said dielectric boundary.

20. The invention of claim 19, further comprising the step of converting at least a portion of said beam of surface plasmons into an output beam of photons after said beam of surface plasmons has encountered said dielectric boundary.

21. The invention of claim 16, wherein:
each of the first and second portions comprises a solid; and
the first and second portions have different thicknesses.
